(19) United States
(12) Patent Application Publication
(10) Pub. No.: US 2013/0242698 A1
(43) Pub. Date: Sep. 19, 2013

(54) Seismic Surveying Using Fiber Optic Technology

(71) Applicants: Magnus McEwen-King, Dorchester (GB); David John Hill, Farnborough (GB)

(72) Inventors: Magnus McEwen-King, Dorchester (GB); David John Hill, Farnborough (GB)

(73) Assignee: OPTASENSE HOLDINGS LIMITED, Hampshire (UK)

(21) Appl. No.: 13/988,719

(22) PCT Filed: Nov. 29, 2011
(86) PCT No.: PCT/GB11/01656

§ 371 Date: May 21, 2013

(30) Foreign Application Priority Data
Dec. 1, 2010 (GB) 1020359.4

(51) Int. Cl. G01V 1/20

(52) U.S. Cl. CPC G01V 1/20
USPC 367/37

(57) ABSTRACT

This application relates to methods and apparatus for seismic surveying using optical fibre distributed acoustic sensing (DAS). The method involves using a fibre optic distributed acoustic sensor to detect seismic signals. The fibre optic distributed acoustic sensor comprises an interrogator (106) arranged to interrogate at least one optical fibre (104) buried in the ground (204) in the area of interest. The method involves stimulating the ground using a seismic source (201) and detecting the seismic signals, for example reflected from various rock strata (202, 203).

The present invention relates to seismic surveying using fibre optic distributed acoustic sensors and in particular to methods and apparatus for surface seismic surveying.

Seismic surveying is used in a variety of applications. For example in the oil and gas sector seismic surveys may be conducted at numerous different stages of well constructions and operation. Initially seismic surveys may be performed during as part of the prospecting or exploration phase as part of the investigations used to identify useful oil and gas reservoirs. Once a reservoir has been identified further seismic surveys may be conducted to try to determine as much as possible about the local rock conditions in a planning stage prior to well drilling. Further seismic surveys may be performed during well construction, for instance at stages in the drilling processor, to detect any changes in the environment due to the drilling or fabrication process. Once well construction has been completed and the wells are operational there may also be a desire to perform periodic seismic surveys in order to highlight any significant changes in the condition of the wells and the reservoir over time.

Seismic surveys are also used for assessing potential sites for the storage of hazardous materials such as nuclear waste for example. Carbon dioxide sequestrations schemes would also rely on seismic surveying to identify suitable reservoirs. In these applications there may again be a desire to undertake periodic seismic surveys to monitor the condition of the site over time.

Conventional seismic surveying involves deploying an array of seismometers over an area of interest and then introducing a stimulus from a seismic source into said area. Various types of seismometer are known but typically (especially in the oil and gas sensor) a geophone array is used. The arrangement of the geophones in the array will vary depending upon the area being surveyed and the type of survey being performed. One type of seismic survey, known as vertical seismic profiling (VSP), involves lowering a string array of geophones down a borehole and measuring the response to a seismic stimulus. Another known type of seismic survey, surface reflection seismology, involves deploying a generally linear array of geophones across the surface of the area of interest and measuring the response to a seismic stimulus delivered to the surface. By determining the response times of reflections of the acoustic stimulus information about the underlying rock strata can be determined.

Various types of seismic source for producing a seismic stimulus are known, for instance explosives or air guns can be used but it is most common, especially in the oil and gas industry, to use one or more a truck mounted seismic vibrators, for example a Vibraseis™ truck. The seismic vibrator is capable of injecting low frequency vibrations into the earth and can apply a stimulus with a time varying frequency sweep.

To perform a surface reflection seismology survey the geophone array must be deployed over the surface of the area of interest. To survey a relatively wide area a large number of geophones may need to be deployed in either a linear arrangement or two dimensional deployment. Once deployed one or more seismic vibrators may be located in an appropriate position and operated to apply a desired seismic stimulus. Measurement of the response of the geophones to the stimulus are recorded and stored for analysis.

Geophone arrays suitable for seismic surveying are relatively expensive, with costs in the order of hundreds of thousands of dollars, and thus the geophone arrays are usually deployed only for the duration of the particular survey. After the survey is complete the array is recovered for use in another survey in a different location. Typically therefore the geophones are deployed in a relatively temporary manner. Whilst in some areas it may be possible to deploy the geophones by simply lying them on the ground in many instances this may provide ineffective coupling between the geophone and the ground especially where there may be significant vegetation. Usually therefore the geophones are mounted on stakes which are driven into the ground to couple the geophone to the earth. Deploying and subsequently recovering the array therefore can involve a significant effort, especially as the area to be surveyed may be relatively wild. This deployment also means that the geophones are exposed to the elements and strong wind or heavy precipitation may affect the readings.

If another survey is required in the future at the same location, for instance to determine whether there have been any significant changes, a geophone array must be redeployed. Ideally in order to provide readings that may easily be compared the deployment of the geophones for any subsequent survey should match the general deployment for the previous survey or surveys. However achieving exactly the same deployment of sensors may be difficult.

It is therefore an aim of the present invention to provide apparatus and methods for seismic surveys, especially surface reflection seismology that mitigates at least some of the above mentioned disadvantages.

Thus according to the present invention there is provided a method of surface seismology surveying comprising using a fibre optic distributed acoustic sensor to detect seismic signals wherein the fibre optic distributed acoustic sensor comprises at least one optical fibre buried in the ground in the area of interest and the method comprises stimulating the ground using a seismic source.

The method of the present invention therefore uses a fibre optic distributed acoustic sensor to detect the seismic signals and thus avoids the need for use of an expensive geophone array.

Fibre optic distributed acoustic sensing (DAS) is a known technique whereby a single length of optical fibre is interrogated, usually by one or more input pulses of light, to provide substantially continuous sensing of acoustic activity along its length. Optical pulses are launched into the fibre and the radiation backscattered from within the fibre is detected and analysed. By analysing the radiation backscattered within the fibre the effect of acoustic signals incident on the fibre can be detected. Rayleigh backscattered light may usefully be detected but the skilled person will appreciate that Brillouin and/or Raman scattering may additionally or alternatively be used. The backscatter returns are typically analysed in a number of time bins, typically linked to the duration of the interrogation fibres and hence the returns from a plurality of discrete sensing portions can be separately analysed. Thus the fibre can effectively be divided into a plurality of discrete sensing portions of fibre. Within each discrete sensing portion disturbance of the fibre, for instance from acoustic sources, cause a variation in the characteristics of radiation which is backscattered from that portion. This variation can be detected and analysed and used to give an indication of any disturbance of the fibre at that sensing portion, for example a measure of the intensity of any disturbance. Whilst such sensors have principally been used to detect acoustic waves it has been found that the fibres are sensitive to any type of mechanical vibration and thus provide an indication of any type of mechanical disturbance along the fibre. It has further been found that a fibre optic distributed acoustic sensor can be used to detect seismic waves including P and S waves.

As used in this specification the term “distributed acoustic sensor” will be taken to mean a sensor comprising an optical fibre which is interrogated optically to provide a plurality of discrete acoustic sensing portions distributed longitudinally along the fibre and which can detect mechanical vibration or incident pressure waves, including seismic waves.

The method may therefore comprise launching a series of optical pulses into said fibre and detecting radiation backscattered by the fibre; and processing the detected backscattered radiation to provide a plurality of discrete longitudinal sensing portions of the fibre. The backscattered radiation may be Rayleigh backscattered radiation. Note that as used herein the term optical is not restricted to the visible spectrum and optical radiation includes infrared radiation and ultraviolet radiation. A suitable DAS system is described in GB2442745 for example, the content of which is hereby incorporated by reference. Such a sensor may be seen as a fully distributed or intrinsic sensor as it uses the intrinsic scattering processed inherent in an optical fibre and thus distributes the sensing function throughout the whole of the optical fibre.

Fibre optic distributed acoustic sensing therefore provides a sensor that can monitor long lengths of optical fibre with good spatial resolution. For instance a fibre optic distributed acoustic sensor can be implemented to monitor up 40 km or more of optical fibre, for a spatial resolution, i.e. size of the individual sensing portions, of the order of 10 m or so. In other words, in use the fibre optics can effectively act as a 40 km linear array vibration sensors with individual sensors being spaced 10 m apart.

The sensor can operate using a standard, preferably single mode, fibre optic cable such as may be used for telecommunications, without the need for deliberately introduced reflection sites such a fibre Bragg grating or the like. The ability to use a unmodified length of standard optical fibre to provide sensing means that low cost readily available fibre may be used and a costly geophone array is not required. As a single fibre of up to 40 km in length can be used as the sensing fibre in many applications only a single fibre is required to provide the extent of sensor coverage required. A single length of telecoms optical fibre may cost of the order of a thousand dollars or so and thus is a few hundred times cheaper than a conventional geophone array.

As the sensing fibre is relatively inexpensive the sensing fibre may be deployed in a location in a more permanent fashion as the costs of leaving the fibre in situ and using a different fibre in a different location are not significant. In the method of the present invention a fibre which is buried in the ground in the region of interest is used as the sensing fibre. The fibre is buried in the ground so as to be strongly coupled to the ground and thus may be buried directly in contact with the ground, i.e. not within an conduit or the like.

The method does therefore require a buried fibre in the area of interest. For the first seismic survey in the area of interest this may require a fibre to be specifically buried in a desired arrangement which will involve some deployment costs. However the fibre does not need to be buried deeply and only a narrow trench will be required to lay a single fibre optic cable. Burying the fibre increases the coupling between the fibre and the ground and also helps to isolate the fibre from the surface weather conditions. A depth of ten centimetres or more may be sufficient for this purpose but to ensure good coupling and to avoid accidental exposure of the fibre, especially if deployed for a long period of time, a depth of the order of 0.5-1 m or so is preferred. It is not usually necessary to bury the fibre much deeper but it could be buried deeper if required. Typically the seismic signals of interest are reflected from much lower depths and so the exact depth at which the fibre is buried is not important. The method may therefore comprise the initial step of burying a suitable fibre optic cable in a desired pattern in the ground in the area of interest.

As mentioned, as the fibre is buried in the ground it is well coupled to the ground and thus offers good performance in detecting seismic waves propagating through the ground. Also as the fibre is buried it is isolated from surface weather effects. Wind and/or precipitation does not affect the operation of the distributed acoustic sensor using a buried fibre, unlike a surface mounted geophone array.

It has been found that a buried fibre optic cable used in a DAS sensor can provide seismic data at least as good as a surface mounted geophone array. The realisation that useful seismic data for seismic surveying of an area can be acquired using a simple buried fibre instead of an expensive specialist geophone array represents an aspect of the present invention.

As mentioned the fibre itself can be left in-situ as the cost of another fibre for use in a different location is relatively trivial. This has the additional benefit that if another survey is required in same location in due course the same fibre can be re-used. As the fibre is buried it is relatively protected from the environment and most typical optical fibres are well suited to being buried for long periods of time. Thus the same fibre can be used for the next survey and the costs of deploying a sensor array for the subsequent survey are avoided. Thus fora location where it is likely that many periodic seismic surveys may be required overtime even if the initial costs involved in deploying a buried fibre are greater than those that would be incurred in deploying a geophone array the fact that the deployment costs for the fibre optic distributed acoustic sensor are only incurred once may mean that overall deployment costs over time are lower when using a DAS sensor.

In addition as the fibre optic is buried and left in situ the fibre will be located in the same place each time that a survey is performed. Thus the results of two surveys which are conducted using the same fibre but conducted at different times can be directly compared to determine any changes occurring over time. The ability to directly correlate the results of surveys conducted at different times is an advantage of using DAS sensors with permanently buried fibres.

As will be appreciated the DAS sensor comprises an interrogation unit which, in use, couples to one end of the fibre under test and transmits optical pulses into the fibre and detects the backscatter from within the fibre. During the seismic survey the interrogation unit will be coupled to the fibre under test. After the survey is completed the interrogation unit may be detached from the fibre and relocated for use with another different buried fibre. Thus only the fibre which is buried may remain in-situ and the interrogation unit itself may be relocated as required. The method may therefore comprise connecting at least one DAS interrogation unit to the end of at least one buried fibre in order to conduct a survey, performing the survey—which may involve stimulating the ground with one or more seismic sources and detecting the seismic signals incident on the fibre—and then removing the interrogation unit at the end of the survey but leaving the fibre in pace. The end of the fibre would be capped for protection and left safe until the next survey. In this way once the sensing fibres are in place in several locations that require periodic surveys the vibration sources and DAS interrogation units may be moved from location to location to perform the surveys without the need to deploy and recover sensor arrays.

In some applications however it may be desired to leave the whole working DAS sensor in-situ, even if a seismic source is only available for performing reflection seismology surveys periodically. A DAS interrogation unit may itself be relatively inexpensive and in some applications it may be wished to provide continual monitoring or at east monitoring on a relatively frequent basis. Such monitoring could analyse the acoustic/seismic signals received in the absence of specific stimuli, i.e. the general ambient acoustic/seismic signals. Such monitoring may help identify any changes in the general background over time and/or identify any significant acoustic/seismic events that may mean a detailed survey is required.

When the sensing fibre is initially buried it may be located in any desired pattern as required. If a one dimensional array of sensor is required a single cable, possibly with one or more additional cables for redundancy, may be buried in a generally straight line. If a two dimensional array of surface sensors are required a single cable could be looped back on itself one or more times to effectively provide a series of parallel lines of sensors. As the sensing cable can be up to 50 km in length various arrangements are possible. For instance the fibre could be deployed in a generally two-dimensional spiral pattern in an area of interest (which may be a curved spiral or a straight-line spiral or a combination). In other words the fibre may be layed in a two-dimensional pattern wherein part of the fibre surrounds other parts of the same fibre. In additional more than one fibre could be buried with the different fibre providing different arrangement so that one or more of the buried fibres could be used in a survey as required.

In one implementation the fibre may advantageously be buried in a generally helical or coiled arrangement about a horizontal axis. The fibre may for instance be coiled around a central mandrel. A coiled arrangement can provide benefits in terms of sensitivity and providing a desired spatial resolution. The axis of the coil may itself follow a curved pattern in two-dimensions.

A DAS sensor using an optical fibre laid in a straight line may have a certain beam pattern dependence, that is the fibre will have a different sensitivity to incident waves that arrive parallel to the axis of the fibre (‘end-on’) as oppose to those waves which arrive perpendicular to the axis of the fibre (‘broadside’). If the fibre was laid in a straight line the fibre would therefore exhibit directional sensitivity and may not be as sensitive in some directions. By coiling the fibre an incident wave from any direction will be incident perpendicular to at least some of the fibre. Thus at least some of the beam pattern dependence is reduced and the sensitivity in some directions may be improved.

Further, the length of the discrete sensing portions of the fibre are determined by the interrogating radiation and sampling rate. It will be understood that in a fibre optic distributed acoustic sensor which is interrogated by pulsed radiation, the spatial resolution of the longitudinal sensing portions of the fibre may typically depend on the duration of the interrogating pulse (and/or the time between pulses). For example in a distributed acoustic fibre optic sensor such as described in GB2,442,745 the spatial length of the longitudinal sensing portions is about 12 m. The length of the longitudinal sensing portions (referred to as the gauge length) may be chosen to provide a desired sensitivity. The longer the gauge length then the greater the sensitivity of each sensing portion, not least because for a longer gauge length longer pulses of interrogating radiation can be used with consequently a greater backscatter signal.

For seismic surveying a gauge length of the order of 40 m or so, for example in the rnage of 30-60 m may be used to provide good sensitivity whilst maintaining an acceptable spatial resolution.

If the optical fibre were deployed such that the fibre were relatively straight, over lengths of at least a few tens of metres (i.e. a few multiples of the gauge length), it will be clear that the effective spatial resolution of the sensor will be the same as the spatial resolution of the longitudinal sensing portions, i.e. gauge length. In other words if the gauge length were 12 m say each longitudinal sensing portions of optical fibre would monitor the acoustic signals incident on a 12 m long stretch of the environment. As mentioned above the gauge length could be varied by changing the interrogating radiation but this would affect the spatial resolution of the sensor.

The fibre may therefore be deployed to provide an effective spatial resolution less than the gauge length. For example, coiling the fibre can increase the length of fibre that is deployed over a certain length of ground as compared to a straight deployment. For instance the fibre could be coiled so that 10 m or so of fibre is deployed in only 1 m of ground. Thus the 10 m of fibre which may comprise a single longitudinal sensing portion of the fibre is responsive to seismic signal effecting a 1 m section of the actual environment. Thus the effective spatial resolution of the sensor in the environment is 1 m. Coiling the fibre may therefore be used to provide a desired effective spatial resolution.

It will of course be appreciated that other fibre geometries are possible to provide a desired spatial resolution, for instance a meandering arrangement, but as mentioned coiling the fibre also can provide sensitivity advantages. It will also be appreciated that the fibre arrangement may be varied along its length to provide different effective spatial resolutions in different areas. For instance the fibre could be coiled at a first pitch to provide a first spatial resolution along a first track then looped back along a parallel track but coiled with a different pitch to provide a different effective spatial resolution.

When the fibre is arranged in a coiled arrangement the optical fibre is preferably polarisation maintaining fibre. The DAS sensor may also comprise a polarisation controller to maintain polarisation.

Whatever the actual geometry of the fibre however it is possible to vary the length of the individual sensing portions of the fibre by varying the properties of the DAS interrogator. Thus provides the ability to vary the spatial resolution in use, whilst performing a survey. This is not possible with a conventional geophone array where the deployment of the geophones is physically fixed. As mentioned above varying the gauge length of the sensor may vary the sensitivity which allows a trade off to be made between sensitivity and resolution during a survey. Again which is not possible with a conventional geophone array.

It will be appreciated that geophone arrays may include three component geophones to separately determine the components of any seismic wave (principally the S waves) in three dimensions. However the present inventors have realised that whilst three component geophones are often used most of the analysis in done using a single component only (or a general magnitude only). Thus separate component analysis is only performed in certain rare occasions. Thus using a DAS sensor provides enough data for the standard analysis used in surface reflective seismology.

During the survey the ground is typically stimulated by an acoustic source such as a Vibroseis™ truck. These seismic sources produce a high energy stimulus in order that seismic waves of sufficient intensity are generated. As the DAS sensor receives the initial stimulus and reflections from various layers of rock it is beneficial that the DAS sensor has a large dynamic range.

In order to provide a large dynamic range the rate of sampling of the sensor may be relatively high so as to reduce the amount of signal change between any two successive samples to aid in reconstruction of the incident signal. This can help reduce effective clipping of the sensor. However a high data rate will produce a large number of samples so once the data has been processed to determine the overall incident signal characteristics the amount of data samples may be reduced to a desired amount, e.g. decimated, to reduce further processing and storage requirements.

When using a seismic vibrator it is typical that the vibration has a time varying frequency. The method may therefore involve correlating the signals detected with the time varying frequency to help determine the seismic signals from background noise.

The invention also relates to a system for surface seismology comprising a seismic source for stimulating the ground with seismic waves; an optical fibre buried in the ground in an area to be surveyed; a source of electromagnetic radiation configured to launch electromagnetic radiation into said fibre; a detector for detecting electromagnetic radiation back-scattered from said fibre; and a processor configured to: analyse the back-scattered radiation to determine a measurement signal for a plurality of discrete longitudinal sensing portions of the optic fibre and analyses said measurement signals to detect incident seismic signals.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention extends to methods, apparatus and/or use substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

The invention will now be described by way of example only with reference to the following drawings, of which:

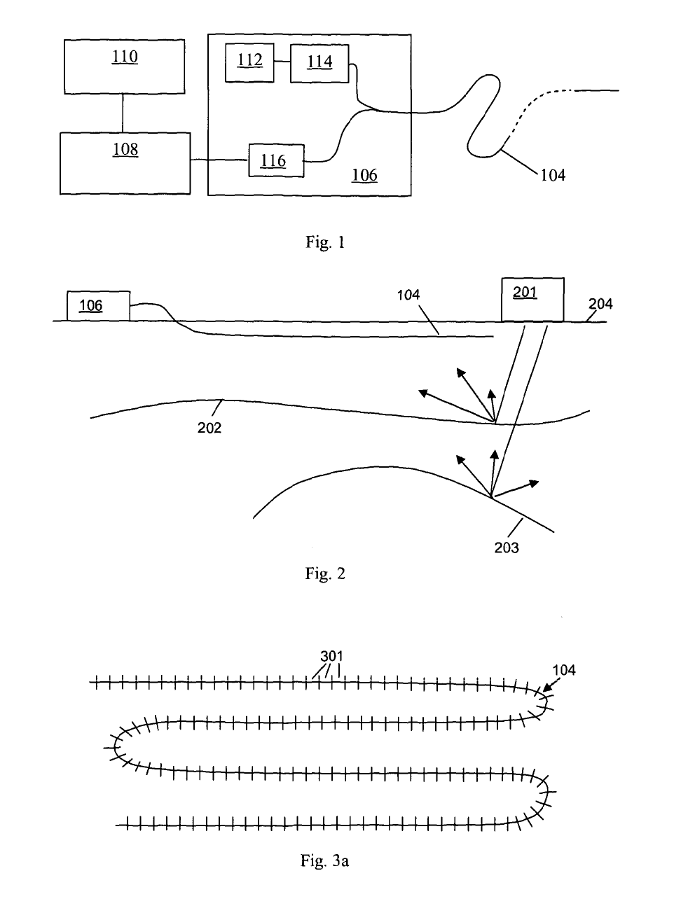

FIG. 1 illustrates the basic components of a distributed fibre optic sensor;

FIG. 2 illustrates a first arrangement of a DAS sensor arranged to provide surface reflection seismology;

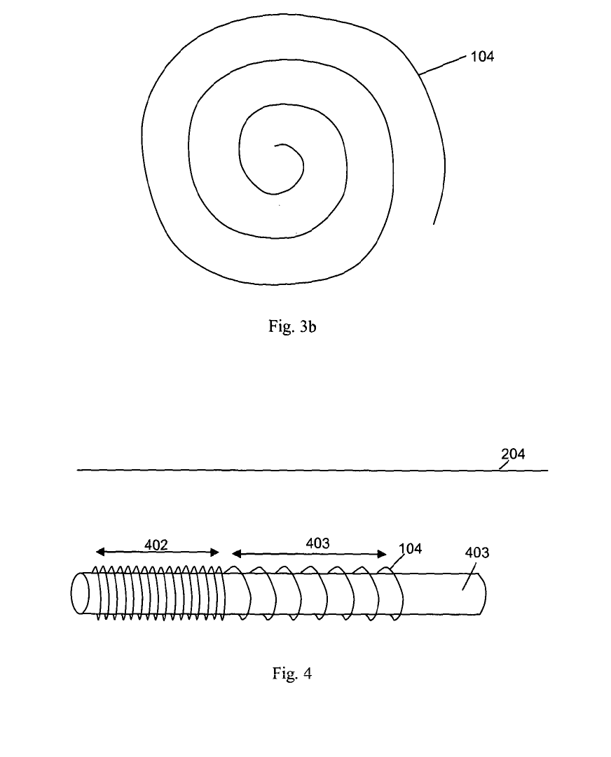

FIGS. 3a and 3b show plan views of other arrangements of a DAS sensor; and

FIG. 4 shows an arrangement using a coiled fibre.

FIG. 1 shows a schematic of a distributed fibre optic sensing arrangement. A length of sensing fibre 104 is removably connected at one end to an interrogator 106. The output from interrogator 106 is passed to a signal processor 108, which may be co-located with the interrogator or may be remote therefrom, and optionally a user interface/graphical display 110, which in practice may be realised by an appropriately specified PC. The user interface may be co-located with the signal processor or may be remote therefrom.

The sensing fibre 104 can be many kilometres in length, for example up to 50 km long, although the length of the fibre may in practice depend on the size of the area of interest and the spatial resolution and deployment required. The sensing fibre may be a standard, unmodified single mode optic fibre such as is routinely used in telecommunications applications. However in some embodiments the fibre may comprise a fibre which has been fabricated to be especially sensitive to incident vibrations. In use the fibre 104 is buried in the ground in an area of interest.

In operation the interrogator 106 launches interrogating electromagnetic radiation, which may for example comprise a series of optical pulses having a selected frequency pattern, into the sensing fibre. The optical pulses may have a frequency pattern as described in GB patent publication GB2,442,745 the contents of which are hereby incorporated by reference thereto. As described in GB2,442,745 the phenomenon of Rayleigh backscattering results in some fraction of the light input into the fibre being reflected back to the interrogator, where it is detected to provide an output signal which is representative of acoustic disturbances in the vicinity of the fibre. The interrogator therefore conveniently comprises at least one laser 112 and at least one optical modulator 114 for producing a plurality of optical pulse separated by a known optical frequency difference. The interrogator also comprises at least one photodetector 116 arranged to detect radiation which is backscattered from the intrinsic scattering sites within the fibre 104.

The signal from the photodetector is processed by signal processor 108. The signal processor conveniently demodulates the returned signal based on the frequency difference between the optical pulses such as described in GB2,442,745. The signal processor may also apply a phase unwrap algorithm as described in GB2,442,745.

The form of the optical input and the method of detection allow a single continuous fibre to be spatially resolved into discrete longitudinal sensing portions. That is, the acoustic signal sensed at one sensing portion can be provided substantially independently of the sensed signal at an adjacent portion. The spatial resolution of the sensing portions of optical fibre may, for example, be approximately 10 m, which for a 40 km length of fibre results in the output of the interrogator taking the form of 4000 independent data channels. Alternatively the length of the sensing portions of optical fibre, which will be referred to as the gauge length may be of the order of 40-60 m or so. A length of 40-60 m allows longer pulses of interrogating radiation to be used with a consequent increase in sensitivity and for seismic surveys a spatial resolution of the order of 40-60 m may be sufficient.

In this way, the single sensing fibre can provide sensed data which is analogous to a multiplexed array of adjacent independent sensors, arranged in a path.

FIG. 2 illustrates a DAS sensor arranged to perform surface reflection seismology. The fibre 104 is buried in the ground 204 within an area to be surveyed. At least one end of the optical fibre is free and unburied and may be connected to interrogator 106.

Interrogator 106 may be permanently connected to the fibre 104 to provide continual acoustic/seismic monitoring but in some embodiments the interrogator is removably connected to the fibre 104 when needed to perform a survey but then can be disconnected and removed when the survey is complete. The fibre 104 though is buried and remains in situ after the survey ready for any subsequent survey. The fibre is relatively cheap and thus the cost of leaving the fibre in place is not great. Leaving the fibre in place does however remove the need for any sensor deployment costs in subsequent surveys and also ensures that in any subsequent survey the sensor is located in exactly the same place as for the previous survey. This readily allows for the acquisition and analysis of seismic data at different times to provide a time varying seismic analysis.

To perform a survey one or more seismic sources 201, for example Vibroseis™ trucks are located and used to excite the ground. This generates seismic waves which propagate through the ground and underlying rock. Different rock strata 202 and/or reservoirs 203 can reflect at least some of the incident seismic waves which then propagate back towards the surface. These seismic waves cause vibration of the optical fibre 104 which is detected and analysed as described above.

Typically the seismic source 201 may apply a stimulus with a time varying frequency pattern and when analysing the data from the DAS sensor a frequency correlation may be applied to isolate the seismic signals of interest from background noise etc.

The stimulus applied by the seismic source 201 may be very energetic and thus any reflection from nearby reflection sites will also be relatively energetic. However the reflections from deeper sites may be significantly attenuated and may be relatively faint. Thus the DAS sensor ideally has a large dynamic range. To help cope with a wide dynamic range the sampling speed of the photodetector 116 and initial signal processing is at a high rate so as to reduce the amount of variation between any two samples. The can aids in subsequent reconstruction of the form of the incident signal. However once the general form of the signal is known a high data rate may not be required and thus the signal processor 108 may decimate the processed data to reduce further processing and storage requirements.

The result will be a series of signals indicating the seismic signals detected over time in each longitudinal section of the fibre. For the time of arrival of the seismic signals at the various sensing portions of the fibre the structural of the underlying rock can be determined using known seismic processing techniques.

The sensing fibre thus effectively acts as a series of point seismometers but at a fraction of the cost of a conventional geophone array. Further, as the fibre optic is buried it is isolated from any surface weather conditions that can affect convention surface mounted geophones.

The fibre is typically buried to depth of about 0.5 to 1 m and thus is very much locate in the upper ground surface.

Various arrangements of the fibre 104 are possible. FIG. 2 shows a basic arrangement where the fibre 104 is buried in a generally straight line. Such an arrangement will allow effectively a two dimensional slice of the underlying ground formation to be analysed.

Other arrangements are possible however. FIG. 3a for example shows a plan view of an arrangement where the 104 fibre is buried in a looped arrangement proving a two dimensional pattern which effectively provides parallel linear arrays of longitudinal sensing portions 301. FIG. 3b shows an alternative arrangement wherein the fibre 104 is deployed in a two-dimensional spiral. A curved spiral is shown but parts of the spiral at least could be straight.

It will of course be appreciated that whilst a single fibre is shown in FIGS. 3a and 3b the same general arrangement could be provided by using multiple fibres.

As mentioned above the fibre is interrogated to provide a series of longitudinal sensing portions, the length of which depends upon the properties of the interrogator 106 and generally upon the interrogating radiation used. The spatial length of the sensing portions can therefore be varied in use, even after the fibre has been buried, by varying the properties of the interrogating radiation. This is not possible with a convention geophone array where the physical separation of the geophones defines the spatial resolution of the system.

In surface reflection seismology in some instances a relatively high spatial resolution may be required, for instance a spatial resolution of the order of 1 m or so may be beneficial in some applications. There may be a limit to the useful spatial resolution that can be achieved by varying the duration of the interrogating pulses of radiation as if the pulse become too short there may be insufficient radiation injected into the fibre to detect sufficient backscatter. In the arrangement shown in FIG. 4 therefore the fibre is coiled so that each longitudinal portion of sensing fibre is deployed over a shorter length of ground. Thus if the length of the sensing portions of the fibre are 10 m or more (e.g. 40 m) as defined by the interrogating radiation but the fibre is coiled such that 10 m of fibre is deployed over only 1 m of ground then a spatial resolution of 1 m can be achieved. The spatial resolution can still be varied in use by changing the properties of the interrogating radiation (or simply combining the results of several adjacent sensing portions).

In some applications the pitch of the coil may be varied in order to change the spatial resolution over the path of the fibre. For instance FIG. 4 shows a first section 401 of fibre 104 coiled with a first pitch and second section 402 coiled with a second pitch. The first section has more coils per unit length than the second pitch and so. For example the effective spatial resolution of the first section may be 1 m whereas the effective spatial resolution of the second section may be 2 m.

For ease in producing the coiled arrangement and to ensure the coli remains in use the fibre 104 may be wound around a mandrel 403.

A coiled arrangement is relatively easy to produce and also provides advantages in terms of reducing directional sensitivity of the fibre as incident seismic waves from any direction will be perpendicular to at least some of the fibre. However other arrangements and geometries of fibre could be used as required.

1. A method of surface seismology surveying comprising using a fibre optic distributed acoustic sensor to detect seismic signals wherein the fibre optic distributed acoustic sensor comprises at least one optical fibre buried in the ground in the area of interest and the method comprises stimulating the ground using a seismic source.

2. A method as claimed in claim 1 comprising launching a series of optical pulses into said optical fibre and detecting radiation Rayleigh backscattered by the fibre; and processing the detected Rayleigh backscattered radiation to provide a plurality of discrete longitudinal sensing portions of the fibre.

3. A method as claimed in claim 1 wherein said optical fibre is permanently buried in the ground.

4. A method as claimed in claim 1 wherein said optical fibre is buried at a depth of 10 cm to 1 m.

5. A method as claimed in claim 1 comprising the step of, prior to performing a first survey in an area of interest, burying said optical fibre cable in a desired pattern in the ground in the area of interest.

6. A method as claimed in claim 5 comprising the step of performing at least one subsequent survey using said optical fibre previously buried.

7. A method as claimed in claim 1 comprising the step of comparing the seismic signals detected at at least two different times using said optical fibre.

8. A method as claimed in claim 1 comprising the step of connecting an interrogator unit to the end of said buried optical fibre to provide said distributed acoustic sensor and, after using said sensor, disconnecting said interrogator unit.

9. A method as claimed in claim 1 wherein said optical fibre is buried in a generally straight line.

10. A method as claimed in claim 1 wherein said optical fibre is buried in a looped arrangement to provide, in use, a two dimensional array of sensing portions.

11. A method as claimed in claim 1 wherein the optical fibre is buried in a generally spiral pattern.

12. A method as claimed in claim 1 wherein the optical fibre is buried in a generally helical or coiled arrangement about a horizontal axis.

13. A method as claimed in claim 12 wherein the optical fibre is coiled around a central mandrel.

14. A method as claimed in claim 1 comprising the step of varying in use, the length of the sensing portions of the distributed acoustic sensor.

15. A method as claimed in claim 1 wherein the distributed acoustic sensor has an effective spatial resolution of 0.5-1.5 m.

16. A method as claimed in claim 1 wherein the length of the sensing portions of the distributed acoustic sensor comprise a fibre length of the order of 15-60 m in length.

17. A method as claimed in claim 1 wherein said optical fibre is polarisation maintaining fibre.

18. A method as claimed in claim 1 wherein the distributed acoustic sensor comprises a polarisation controller to maintain polarisation.

19. A method as claimed in claim 1 wherein the seismic source provides a stimulus with a time varying frequency and wherein the method comprises correlating the output of the distributed acoustic sensor with the time varying frequency.

20. A system for surface seismology comprising a seismic source for stimulating the ground with seismic waves; an optical fibre buried in the ground in an area to be surveyed; a source of electromagnetic radiation configured to launch electromagnetic radiation into said fibre; a detector for detecting electromagnetic radiation back-scattered from said fibre; and a processor configured to: analyse the back-scattered radiation to determine a measurement signal for a plurality of discrete longitudinal sensing portions of the optic fibre and analyses said measurement signals to detect incident seismic signals.
